(19) United States
(12) Patent Application Publication
(10) Pub. No.: US 2010/0278335 A1
(43) Pub. Date: Nov. 4, 2010

(54) Arrangements for Location-Based Security Systems and Methods Therefor

(76) Inventors: Per Enge, Mountain View, CA (US); David De Lorenzo, Palo Alto, CA (US); Truc De Lorenzo, Palo Alto, CA (US)

Correspondence Address: CRAWFORD MAUNU PLLC, 1150 NORTHLAND DRIVE, SUITE 100, ST. PAUL, MN, 55120, US

(21) Appl. No.: 12/263,866

(22) Filed: Nov. 3, 2008

Related U.S. Application Data
(60) Provisional application No. 60/985,061, filed on Nov. 2, 2007.

(51) Int. Cl. H04L 9/08

(52) U.S. Cl. 380/45

(57) ABSTRACT

Aspects are applicable to secure encryption such as in the generation of a cryptographic key from location information as may be useful in portable/wireless communication devices. As an example, one embodiment is implemented as a method of generating cryptographic keys from location information derived from a signal received from a publicly-used wireless communication system. The location information is protected from fraudulently generated signals using direction of arrival of the received signal. The method attempts to verify that the direction of arrival corresponds to an expected direction of arrival for a received signal of the primary signal type, and in response to the direction of arrival being verified for the direction of arrival, and then enables use of an encryption key that is generated from positional information derived from the received signal

### RELATED PATENT DOCUMENTS

This patent document claims the benefit, under 35 U.S.C. §119(e), of U.S. Provisional Patent Application Ser. No. 60/985,061 filed on Nov. 2, 2007 and entitled “Arrangements for Location-Based Security Systems and Methods Therefor;” this patent document is fully incorporated herein by reference.

### FIELD OF THE INVENTION

The present invention relates generally to location-based security arrangements and methods.

### OVERVIEW

Satellite-based navigation systems provide position information for a variety of applications. The position information is determined with respect to distances between receivers and transmitters. GNSS (Global Navigational Satellite System) such as Global Positioning System (GPS)/Navstar or GLONASS provide specific examples of satellite-based navigations. In particular, GPS includes a number of medium-earth orbit (MEO) satellites that simultaneously transmit signals. GPS receivers determine their position by computing the relative times of arrival (TOA) of simultaneous signals. GPS satellites transmit ephemeris data that includes satellite positioning data and timing data. The timing data is used to synchronize the receiver's clock to the clock of the satellite. This allows for the use of less accurate clocks by the receiver. The satellite positioning data includes two positioning components, a code-based component and a carrier-frequency-based component. GPS receivers determine the position of the receiver by comparing locally generated code and/or carrier components using the timing data. The locally generated components include values that are measured against the signal received from each satellite to determine the signal delay due to the distance from each satellite.

GPS signals are transmitted at relatively low signal strengths. These low signal strengths can be exploited by those wishing to adversely affect the operation of a receiving device. An attacker may attempt to interfere with a receiving device's capability of detecting the GPS signals by introducing noise (e.g., transmitting undesirable RF signals) or jamming the GPS receiver. A potentially more problematic attack is one in which the attacker mimics (spoofs) the true GPS signal so as to produce erroneous location information. Such an attack is facilitated by the low level of the true GPS signals because a local transmitter can easily produce a stronger signal level, thereby overriding the true signal.

In accordance with various aspects of the present invention, systems, methods and devices are directed to a cryptographic key from location information. Location information is derived from a signal received from a publicly-used wireless communication system, such as GPS. The location information is protected from fraudulently generated signals using direction of arrival (DOA) of the received signal. The implementation involves verifying that, for the received signal, the direction of arrival corresponds to an expected direction of arrival. Use of an encryption key, which is generated from positional information, is conditionally based upon the result of the verification. In certain implementations, one or more of the above features are configured and operated by the same or by separate (disparate) entities. For example, in a method of generating cryptographic keys from location information derived from a signal received from a publicly-used wireless communication system, the location information being protected from fraudulently generated signals using direction of arrival of the received signal, one such entity may be attempting to verify that the direction of arrival corresponds to an expected direction of arrival for a received signal of the primary signal type, and another such entity may be, in response to the direction of arrival being verified as corresponding to the expected direction of arrival, enabling use of an encryption key that is generated from positional information derived from the received signal.

### BRIEF DESCRIPTION OF THE DRAWINGS

The invention may be more completely understood in consideration of the following detailed description of various embodiments of the invention in connection with the accompanying drawings, in which:

FIG. 1 shows a block diagram of a system for generating an encrypted key, according to an example embodiment of the present invention;

FIG. 2 shows a block diagram of a system for generating an encrypted key using an additional positional signal source, according to an example embodiment of the present invention; and

FIG. 3 shows a flow diagram for implementing different levels of access using multiple positional signal sources, according to an example embodiment of the present invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the scope of the invention, including that described in the claims.

### DETAILED DESCRIPTION

The present invention is believed to be applicable to secure encryption and arrangements and approaches for implementing the same. While the present invention is not necessarily limited to such applications, an appreciation of various aspects of the invention is best gained through a discussion of examples in such an environment.

Consistent with one embodiment of the present invention, a method is implemented to generate a cryptographic key from location information.

Consistent with another embodiment of the present invention, failure to verify the authenticity of the (primary) received signal results in the use of a secondary location signal to indicate a valid location. In a specific example, the primary signal is a GPS signal and the secondary signal is from a land-based transmitter. The secondary signal can increase the confidence that location of the device is not fraudulent. This can be applied both to instances where the primary signal is verified and to instances where the primary signal is not verified.

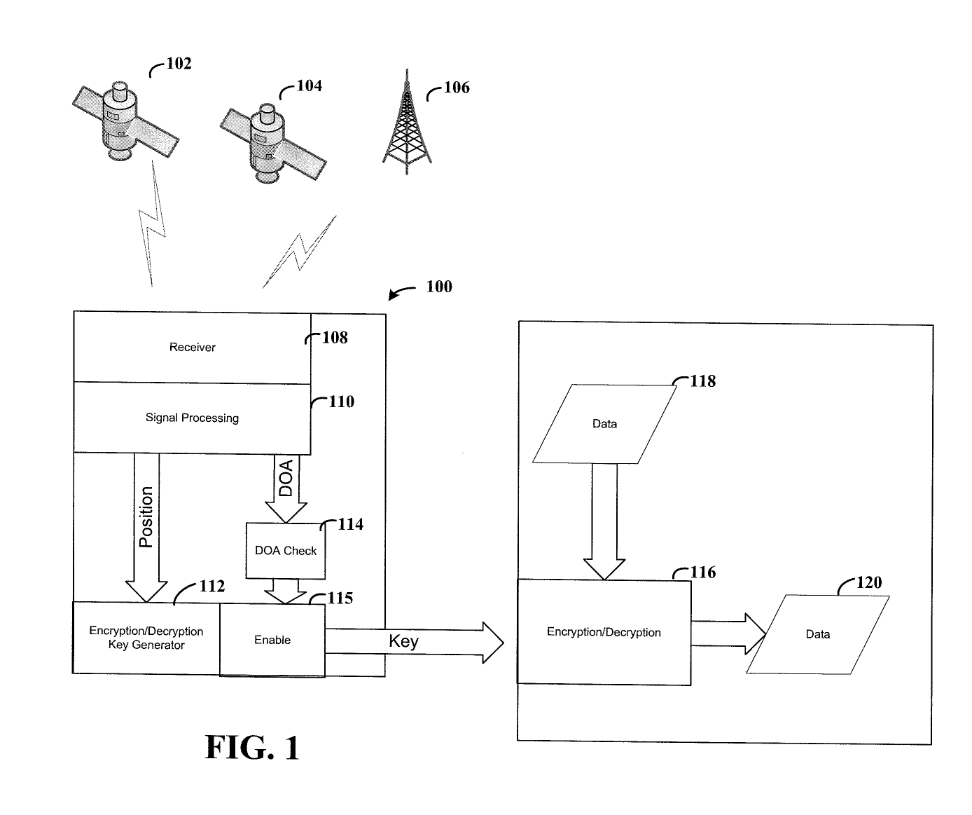

FIG. 1 shows a block diagram of a system for generating an encrypted key, according to an example embodiment of the present invention. One or more of transmitters 102, 104 and 106 provide wireless signals. Device 100 receives the wireless signals via wireless receiver 108. Signal processing 110 determines, from the wireless signals, the position of device 100. Using the determined position, encryption/decryption key generator 112 provides a key that can be used in securing data. Signal processing 110 also determines the direction of arrival of the received wireless signals. The direction of arrival is used to verify that the received signals originated from one of transmitters 102, 104 and 106. If the direction of arrival is not verified, DOA check 114 and enable 115 can be configured to block the use of the generated key. In another instance, DOA check 114 and enable 115 can prohibit the key from being generated.

In one instance, DOA check 114 compares the received DOA to an expected DOA. The expected DOA can be determined using a database of transmitter locations. For fixed transmitters, the expected DOA can be determined through a comparison of the known location of the transmitter to the determined location of device 100. For mobile transmitters, such as satellites, the known location of the transmitters (and resulting expected DOA) is determined as a function of time. This can provide an additional temporal security aspect that a potential spoofing signal would need to account for in addition to DOA. For example, the use of a DOA check can require that a potential spoofing signal's space-time covariance match the target location and time before it would be accepted.

Encryption/Decryption block 116 uses the generated key to either encrypt or decrypt data 118 to generated data 120. For instance, device 100 may be configured to only allow access to data 118 when the device is located at secured location(s). Data 118 is encrypted such that the data can only be decrypted using a key generated from location data corresponding to the secured location(s). In another instance, the device 100 may want to secure data 118 so that it can only be decrypted at the current location. The generated key is used to encrypt data 118 to produce encrypted data 120. Access to encrypted data 120 can then be limited to when the device is located at the desired location(s).

In a specific embodiment of the present invention, receiver 108 uses a multiple antenna array. This can be useful for determining the direction of arrival of a received signal using, for example, phase interferometer techniques. Differences between the phases of the signals received on each of the antenna can be compared to determine the direction of arrival of the signals. Examples of direction of arrival techniques include those used in connection with U.S. Pat. No. 6,127,974 to Kesler, issued Oct. 3, 2000, which is fully incorporated herein by reference.

In one embodiment of the invention, an angular orientation sensor can be used. The device can use the sensor to determine how the antenna array is orientated (e.g., a compass to determine the direction of the Earth's poles). The orientation information is used in combination with the determined direction of arrival for received signals to ascertain the position of the transmitter. This can be particularly useful for use in mobile devices that can easily change their location and orientation (e.g., handheld devices and devices in vehicles). This can also be useful for signal acquisition and tracking. For instance, the receiver may use the orientation to assist in spatial/directional filtering to filter out noise.

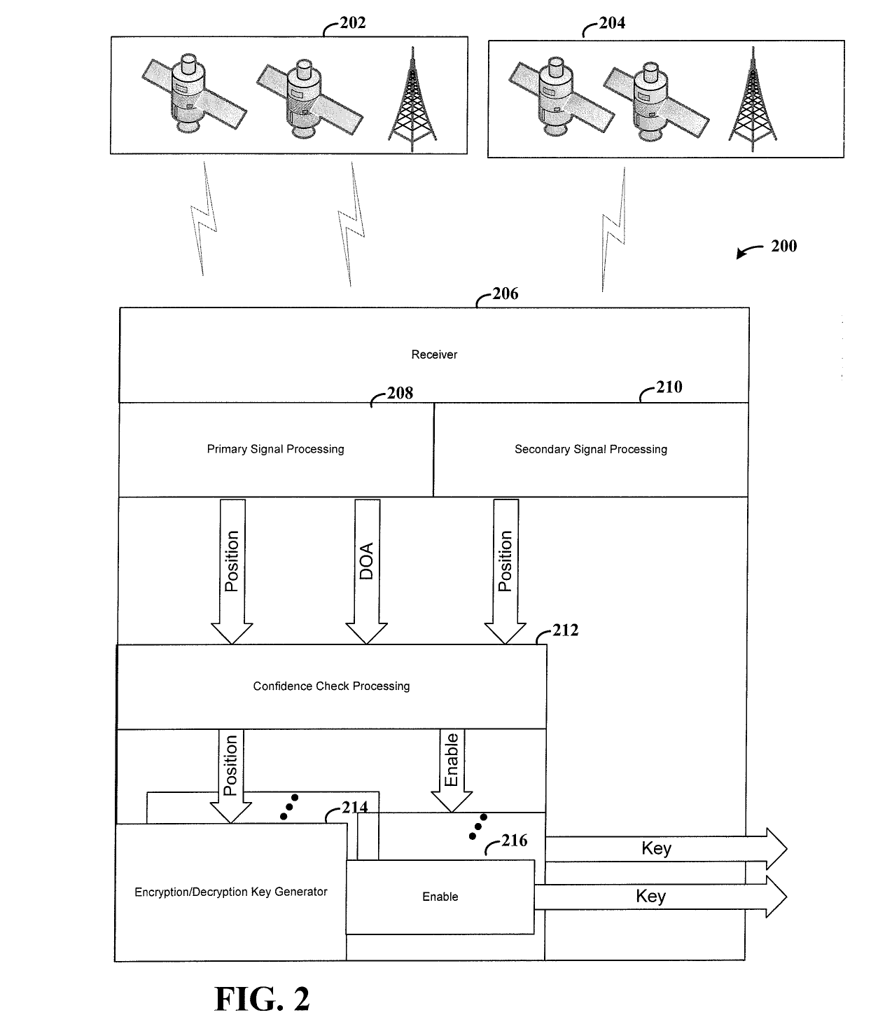

FIG. 2 shows a block diagram of a system for generating an encrypted key using an additional positional signal source, according to an example embodiment of the present invention. Signal source(s) 202 are received by device 200 using receiver 206. Signal processing 208 determines the location of device 200 using received signals 202. Signal processing 208 also determines the direction of arrival of received signals 202. Confidence check processing 212 controls the generation and/or availability of an encryption key generated from encryption/decryption key generator 214. The encryption key is generated using the determined position. The combination of DOA check 212 and enable block 216 serves as gatekeepers for the encryption key.

Additional security and functionality can be implemented through the use of a secondary signal source 204. For example, if signals from source 202 cannot be verified against the expected DOA, then the device can attempt to verify the location information using secondary signal sources 204. Secondary signal processing 210 determines location information using signals from the secondary source 202. If the location information from the secondary source can be verified, then confidence check processing 212 can allow the use of the secure key. If desired, signals from secondary source 202 can also be verified using a DOA check.

In another example, signals from secondary source 204 can be used in situations where signals from primary source 202 are not available (e.g., due to noise or weak signal). This can be particularly useful for providing redundancy in the positional information. The use of a secondary positioning system can also be particularly useful for position critical application, such as E-911 requirements for mobile phones.

In another embodiment of the invention, the device can provide multiple security settings based upon the available information. For instance, if no positional signals are available, the device can set the confidence level to the lowest level. Different levels can be implemented depending on the number of signals available and the confidence in the integrity of the signal. The different security levels can be implemented, for example, by enabling different sets of encryption/decryption keys. This allows for the use of less secure applications and data in situations where the signal cannot be fully verified. This can be particularly useful for allowing use of the device and a subset of all applications/data with less confidence in the security while still maintaining a high confidence in the security of other data. The confidence settings could also use other information to determine the integrity of the signal. For example, the signal-to-noise ratio could be monitored alone or in conjunction with the RF front-end automatic gain control. The checks can monitor for abnormalities in the background noise as well as in any differential between antennas.

In another embodiment of the invention, the secondary signal can be used to verify that the DOA of the primary signal is correct. For instance, the primary signal may be a GPS signal. GPS signals are easily blocked by solid structures and often cannot be detected in buildings or underground. It may still be desirable to allow use of the positional information and of the secure information in such locations. A GPS transmitter could be placed near the desired use point to allow for the use of GPS location determination near the transmitter. The transmitter functions similar to how a spoofing device would be implemented, except that the signal can be considered trustworthy. For such local transmitters, it is likely that the DOA will not match the expected DOA for the satellite transmitter that the local transmitter is emulating. In such a case, the secondary signal can be used to verify that the location information is correct. In this manner the secondary signal can be used in place of the DOA. In a specific instance, the device can verify that the current location is a location with a known local transmitter.

A number of different techniques can be implemented for determining the positional determination including, but not limited to, angle of arrival, time of arrival, time difference of arrival and strength of the signal. These and other techniques can be used to determine positional information from various transmitters including, but not limited to, satellite navigation systems (e.g., GPS), terrestrial navigation systems (e.g., LORAN) and communications systems (such as FM or AM broadcasts, cellular communications and Wi-Fi signals).

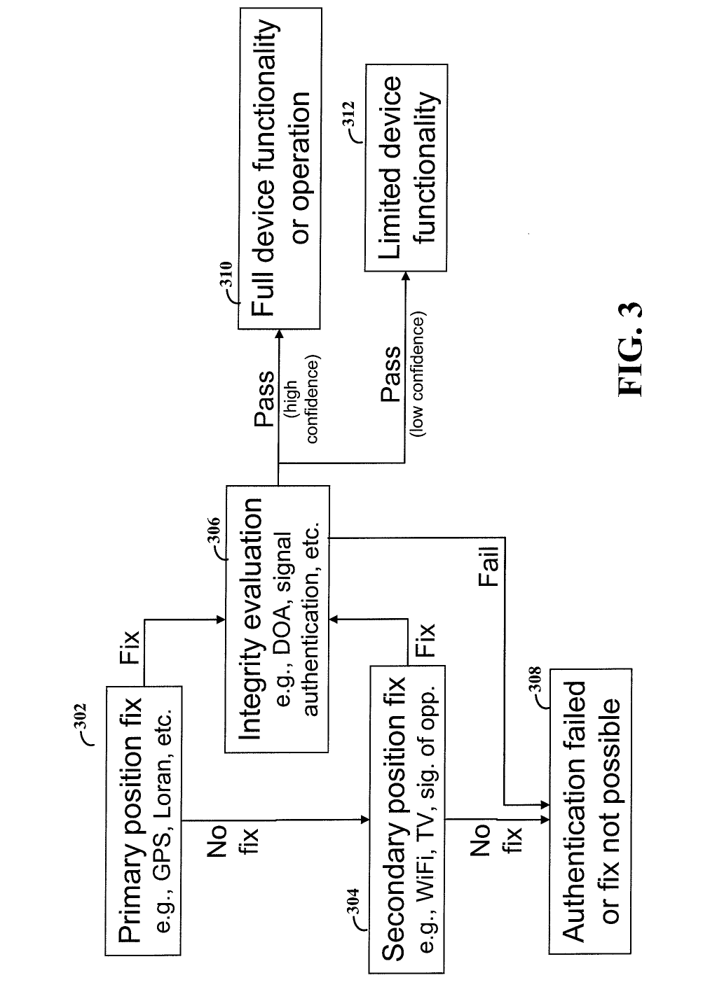

FIG. 3 shows a flow diagram for implementing different levels of access using multiple positional signal sources, according to an example embodiment of the present invention. At block 302, the device attempts to determine a location using a first (primary) positional signal source, such as GPS or LORAN. If a fix is not possible using the first positional source, a fix is attempted using a secondary positional source as shown at block 304. If a fix is obtained by either signal sources, the confidence level of the signal can be determined at block 306. The confidence level can include a direction of arrival determination as well as any number of additional checks. For example, the strength of the signal can measured to detect a possible erroneous signal. Different levels of accessibility can be implemented according to the result of the determination at block 306. For instance, a high confidence allows a user full access to the device, as shown by block 310, whereas a low confidence only allows limited access to the device, as shown by block 312. Block 308 shows a third possibility where no fix is possible from either positional source. In such a case access the device can be further limited or even completely barred.

A specific embodiment of the present invention is implemented to protect from theft of an electronic device, such as a notebook computer. A highly secure mode (310) of the device requires position fix (from a primary or secondary source) and also a high integrity determination before access to the device is granted. In such a mode, all data on the hard drive (for example) is accessible to the authorized user. This could also be implemented to limit access to secure work sites during approved work hours.

A limited device operation mode (312) can also be implemented in conjunction with or separate from other modes discussed herein. Such a mode requires position fix with lower integrity determination. While in this mode, only non-sensitive data on the hard drive (for example) is accessible to the user. Such an application could be implemented to allow limited access at non-secure work sites or during non-approved work hours.

Another possible mode (block 308) results in the device being inoperable from either an unsuccessful position fix or one that fails the integrity determination. In such a mode, no data on the hard drive (for example) is accessible to the user. This mode could be implemented where the device is stolen or used in an unapproved manner. In addition, the device can be configured to send an alert message to the appropriate management entity. The alert message could potentially include positional information that can be used to retrieve the device.

The encryption methods can be implemented using various techniques including, but not limited to, Advanced Encryption Standard (AES), Data Encryption Standard (DES), and International Data Encryption Algorithm (IDEA). In a particular embodiment, various geo-encryption techniques can be used. For further details regarding an example of such a technique reference can be made to U.S. Pat. No. 7,143,289 to Denning, et al., issued Nov. 28, 2006, which is fully incorporated herein by reference.

The various processing steps can be implemented using a variety of devices and methods including general purpose processors implementing specialized software, digital signal processors, programmable logic arrays and discrete logic components.

The various embodiments described above and shown in the figures are provided by way of illustration only and should not be construed to limit the invention. Based on the above discussion and illustrations, those skilled in the art will readily recognize that various modifications and changes may be made to the present invention without strictly following the exemplary embodiments and applications illustrated and described herein. For instance, various aspects of the present invention may be application for use with a variety of positional systems whether they are currently in existence or have yet to be implemented. These approaches are implemented in connection with various example embodiments of the present invention. Such modifications and changes do not depart from the true scope of the present invention, including that set forth in the following claims.

What is claimed is:

1. A method of generating cryptographic keys from location information derived from a signal received from a publicly-used wireless communication system, the location information being protected from fraudulently generated signals using direction of arrival of the received signal, the method comprising the steps of:
attempting to verify that the direction of arrival corresponds to an expected direction of arrival for a received signal of the primary signal type; and
in response to the direction of arrival being verified as corresponding to the expected direction of arrival, enabling use of an encryption key that is generated from positional information derived from the received signal.

2. The method of claim 1, further including the step of, in response to the direction of arrival failing to be verified, using a secondary location signal to indicate a valid location.

3. The method of claim 1, wherein the direction of arrival is determined using a multiple-antenna receiver.

4. The method of claim 3, wherein the direction of arrival is determined using a space-time covariance function.

5. The method of claim 1, further including the step of controlling the availability of multiple encryption keys.

6. The method of claim 5, wherein the step of controlling the availability is responsive to a determination of a level of confidence of the positional information.

7. A system for implementing the method of claim 1, wherein one entity is set up for attempting to verify that the direction of arrival corresponds to an expected direction of arrival for a received signal of the primary signal type, and
another entity is set up in response to the direction of arrival being verified as corresponding to the expected direction of arrival, enabling use of an encryption key that is generated from positional information derived from the received signal.

8. An apparatus for generating cryptographic keys from location information derived from a signal received from a publicly-used wireless communication system, the location information being protected from fraudulently generated signals using direction of arrival of the received signal, the apparatus comprising:
first means for attempting to verify that the direction of arrival corresponds to an expected direction of arrival for a received signal of the primary signal type; and
second means, responsive to the direction of arrival being verified as corresponding to the expected direction of arrival, for enabling use of an encryption key that is generated from positional information derived from the received signal.

9. The apparatus of claim 8, wherein the means for attempting includes a logic circuit configured and designed for verifying that the direction of arrival corresponds to an expected direction of arrival for a received signal of the primary signal type.

10. The apparatus of claim 9, wherein the logic circuit includes a configuration of data stored in a storage medium which data is used to program the logic circuit for attempting to verify that the direction of arrival corresponds to an expected direction of arrival for a received signal of the primary signal type.

11. The apparatus of claim 8, wherein the logic circuit includes a software-programmed computer.

12. The apparatus of claim 8, wherein at least one of the first and second means include a software-programmed computer.
